(19) United States
(12) Patent Application Publication
(10) Pub. No.: US 2017/0280522 A1
(43) Pub. Date: Sep. 28, 2017

(54) Method And Apparatus For Modulating Load By Means Of A Control Command Obtained By Varying The Conduction Angle Of AC Voltage

(71) Applicant: Jaguar Precision Industry Co., Ltd., New Taipei City (TW)

(72) Inventors: Fei-Tyh CHUANG, New Taipei City (TW); Zhen-Gong Xie, Yangmei City (TW); Lu-Ting Huang, Dounan Township (TW)

(73) Assignee: Jaguar Precision Industry Co., Ltd., New Taipei City (TW)

(21) Appl. No.: 15/080,688

(22) Filed: Mar. 25, 2016

(51) Int. Cl. H05B 33/08; H02M 7/06

(52) U.S. Cl. CPC H05B 33/0815; H02M 7/06; H05B 33/0848

(57) ABSTRACT

A method and apparatus for modulating a load by means of control command obtained by varying conduction angle of AC voltage is provided. Under normal operation, conduction angle of AC is approximate to 180 degrees. When a state change command of the load is to be executed, the angle of conduction angle is changed by a conduction angle modulation circuit of control end. After a conduction angle detection circuit of the load end detects the conduction angle, a control unit decodes the information of the conduction angle, and controls the load to perform a corresponding operation. The method and apparatus do not need to add an extra control wiring for the load, and may use the conduction angle of an AC power supply to effectively perform multifunctional modulations on the load with existing power lines, and the defect of a low power commonly found in a traditional dimmer is overcome.

### FIELD OF THE INVENTION

The present invention relates to a method and apparatus for modulating an electrical appliance, particularly to a method and apparatus that make use of a control command generated by modulating the conduction angle of an AC voltage to control the load.

### DESCRIPTIONS OF THE RELATED ART

With the evolution in technology, a variety of electronic products are becoming popular in daily life. The lighting equipment, for example, is getting mature with light emitting diode (LED) technology. Various lamps using LED as light source is also getting popular. LEDs use recombination of electron-hole pairs in luminescence in comparison to traditional bulbs which have to heat filaments to a very high temperature in order for luminescence, so that LEDs do not consume too much energy, and can achieve the goal of energy saving.

As a light source, dimming is very important. It not only creates a more comfortable environment at home, but also reduces unnecessary lighting, thereby realize the effects of energy saving and carbon reduction, which is particularly important nowadays. However, for existing technologies, pulse width modulation (referred to as PWM hereinafter) is preferred for LED dimming. In dimming using PWM, a simple PWM generator may be installed in a switch on a wall, followed by using a potentiometer to control duty cycle (duty) of PWM for realization of dimming. Nevertheless, a pair of control wires has to be further added.

Alternatively, a transwitch dimmer may be used without having to add extra control wires. Existing power wires are sufficient for both dimming and acting as switches. However, the transwitch dimmer has many disadvantages, including: (1) the thyristor can destruct the waveform of sinusoidal wave of alternate current such that power factor value is reduced, and the power factor deteriorates as the conduction angle gets smaller; (2) the thyristor may destruct the waveform of sinusoidal wave of alternate current, and thus the non-sinusoidal waveform will have increased harmonic coefficients; (3) the destructed non-sinusoidal waveform will generate serious interference signal (EMI) on lines.

As for existing technologies, remote controller is further used to realize dimming for LEDs. Certainly, this is an ideal solution where the turning on or off of the light, and the use of PWM for continuous dimming are possible. However, there are disadvantages for dimming with remote controller. The cost is high, and there is no unified specification. Mostly, it is used for illumination dimming in high grade residences.

In addition to lighting equipment, other passive electrical appliances, such as the fan, air conditioner etc., can also be designed with a modulating apparatus, which are usually classified into remote control and wall control (wire control). However, as mentioned above in relation to the dimming technologies, wall hanging controls generally need to have existing wiring modified, and thus will render it difficult and complicated to install and maintain the products.

### SUMMARY OF THE INVENTION

The present invention provides a method and apparatus that modulates a conduction angle of an AC power supply to generate a control command for controlling and operating a load. It is simple in assembly, low in cost, and does not require to alter the original wiring. The load can be operated and the state modulated simply with the use of existing power lines.

As opposed to existing technology that uses a dimmer to change the conduction angle of the power supply so as to control the mode of energy transfer, the present invention simply uses a conduction angle of an alternating current as a control signal, and varies the conduction angle only when a command control is needed. Moreover, when acting as the control command to control the variation of the conduction angle, the conduction angle may be controlled to be 135 degrees or more. As such, the phenomena where the conduction angle and the power factor are being too low may be avoided. Furthermore, it may act as a remote controller and may also be used for multiplexing control by means of effective planning of the conduction angle.

To attain the above-mentioned objects, a modulating apparatus according to the present invention comprises a conduction angle modulation circuit at a control end, and a conduction angle detection circuit and a control unit at a load end, wherein the conduction angle modulation circuit is electrically connected to an AC power supply and is used for modulating a conduction angle of the AC power supply. In addition, at the load end, the conduction angle detection circuit and the control unit are included; wherein the conduction angle detection circuit is electrically connected to the conduction angle modulation circuit for detecting the modulated conduction angle and then outputting a conduction angle signal. Additionally, the control unit is electrically connected to the conduction angle detection circuit and a load driving circuit. The conduction angle is constant during stable operation; when an operating state of a load is to be changed, the conduction angle modulation circuit modulates the conduction angle of the AC power supply, and outputs the conduction angle signal to the control unit after it is detected by the conduction angle detection circuit. A control command is generated after the control unit decodes the conduction angle signal, and the operation of the load is controlled according to the control command.

Preferably, at the load end of the invention, a rectifying circuit is provided to rectify the modulated AC power supply, and a bleeder circuit may be added if the conduction angle modulation circuit uses a triple-pole AC switch for dimming. In addition, the bleeder circuit is used to provide a conduction current for maintaining the conduction of the triple-pole AC switch.

The signal modulating modes for the conduction angle modulation circuit according to the present invention can be roughly classified into two aspects. The first aspect is modulating the conduction angle without using a microprocessor, in which the size of the conduction angle is used as the control command. The second aspect is modulating the conduction angle by means of a microprocessor, in which not only the size of the conduction angle is used as the control command, but also a serial conduction angle signal sequence is generated; wherein the signal sequence may comprise modulation coding and controlled load coding, and check coding, if necessary so as to realize multifunction and accurate multiplexing remote controlling.

According to the first aspect of the present invention, the signal modulating mode for the conduction angle modulation circuit may comprise: a triple-pole AC switch (TRIAC) having a first terminal, a second terminal and a gate, the first terminal being electrically connected to the AC power supply, the second terminal being electrically connected to the load; a bipolar AC switch (DIAC) having a first anode terminal and a second anode terminal, the first anode terminal being connected to the gate of the triple-pole AC switch; a resistor which is electrically connected to the second terminal of the triple-pole AC switch; a capacitor having a first end electrically connected to the resistor and the second anode terminal of the bipolar AC switch, and a second end electrically connected to the first terminal of the triple-pole AC switch; at least one switched capacitor connected with at least one change-over switch in series, the at least one switched capacitor being connected with the capacitor in parallel after being connected in series with the at least one change-over switch. Accordingly, the conduction angle of the alternating current can be modulated by switching the at least one change-over switch to change the corresponding conduction angle modulation circuit.

Preferably, the at least one switched capacitor comprises a first switched capacitor and a second switched capacitor, the at least one change-over switch comprises a first change-over switch and a second change-over switch; the first switched capacitor is connected with the first change-over switch in series, and then connected with the capacitor in parallel; the second switched capacitor is connected with the second change-over switch in series, and then connected with the capacitor in parallel. The change-over switches of the invention may be membrane switch, bounce switch, or other equivalents.

Hence, the above-mentioned conduction angle modulation circuit varies the conduction angle directly by switching the capacitors. The control modes resulted from such conduction angle modulation method will vary with the amount of the switched capacitors and change-over switches provided. That is, the greater the amount of the switched capacitors and change-over switches are disposed, the greater the amount of the control modes will result. Alternatively, the switched capacitors may be replaced with switched resistors. Likewise, the control modes will vary with the amount of the switched resistors and change-over switches provided.

According to the second aspect of signal modulation of the present invention, two types of conduction angle modulation circuits that adopt a triple-pole AC switch are proposed. For the first type of the conduction angle modulation circuit, the sources of the rectifying circuit are input from two terminals of the AC power supply, and the circuit may includes a triple-pole AC switch, a drive circuit for the triple-pole AC switch, a rectifying/DC power supply circuit, a zero-crossing detection circuit, a microcontroller circuit and a modulation module.

The triple-pole AC switch comprises a first terminal, a second terminal and a gate, the second terminal being electrically connected to the load end; the drive circuit for the triple-pole AC switch is electrically connected to the gate of the triple-pole AC switch; the rectifying/DC power supply circuit is electrically connected to both power supply terminals of the AC power supply, and provides DC power supply for each of the circuits; the zero-crossing detection circuit is electrically connected to the rectifying/DC power supply circuit for detecting a zero-crossing signal of the alternating current; the microcontroller circuit is electrically connected to the zero-crossing detection circuit and the drive circuit for the triple-pole AC switch, the microcontroller circuit drives the triple-pole AC switch by controlling the drive circuit for the triple-pole AC switch to modulate the conduction angle of the alternating current according to the zero-crossing signal of the alternating current provided by the zero-crossing detection circuit; the modulation module is electrically connected to the microcontroller circuit, such that the microcontroller circuit may generate AC signals composed of different combinations of conduction angles in a controlled manner.

Accordingly, in the present invention, a microcontroller is actuated by the action of modulation module to control the conduction angle modulation circuit to generate the AC signals of the corresponding conduction angle signal sequence. The above-mentioned modulation module may be a change-over switch, key, or other switching elements of the equivalent effect, or a variable resistor, or combinations thereof. If a change-over switch, key, or other switching element of the equivalent effect is used, the microprocessor may control the conduction angle modulation circuit to generate the AC signal of the corresponding conduction angle signal sequence according to the switch pressed, or a control mode preset by the change-over switch or key. On the other hand, if a variable resistor is used, the conduction angle modulation circuit is controlled to generate the AC signal of the corresponding conduction angle signal sequence according to the variations of the voltage setting.

The second type of conduction angle modulation circuit differs from the aforementioned first type circuit in that the two AC power supplies of the rectifying circuit of the second type circuit are input from the first and second terminals of the triple-pole AC switch, respectively, such that the DC power supply circuit may be supplied with power when the triple-pole AC switch is not conducted. As such, the load end may be controlled simply by connecting one power line to this conduction angle modulation circuit. In brief, connection of both fire wire and ground wire of the AC power supply is needed for the first type of conduction angle modulation circuit, but only connection of either the fire wire or the ground fire is needed for the second type circuit. As such, the problem regarding wiring is solved.

The second type of conduction angle modulation circuit includes essentially a triple-pole AC switch, a triple-pole AC switch drive circuit, a rectifying circuit, a zero-crossing detection circuit, a microcontroller circuit, a DC power supply circuit and a modulation module. The triple-pole AC switch comprises a first terminal, a second terminal and a gate, the second terminal being electrically connected to a load end. The drive circuit for the triple-pole AC switch is electrically connected to the gate of the triple-pole AC switch. The rectifying circuit comprises an AC terminal electrically connected to the first terminal of the triple-pole AC switch, and a DC terminal electrically connected to the second terminal of the triple-pole AC switch. The zero-crossing detection circuit is electrically connected to the rectifying circuit for detecting a zero-crossing signal of an alternating current. The microcontroller circuit is electrically connected to the zero-crossing detection circuit and the drive circuit for the triple-pole AC switch, the microcontroller circuit may drive the triple-pole AC switch by controlling the drive circuit, so as to modulate a conduction angle of the alternating current according to the zero-crossing signal of the alternating current provided by the zero-crossing detection circuit. The DC power supply circuit provides DC power supply for each of the circuits. The modulation module is electrically connected to the microcontroller circuit, such that the microcontroller circuit is activated to generate AC signals composed of different combinations of conduction angles in a controlled manner.

Accordingly, the microcontroller may be actuated by the modulation module to control the conduction angle modulation circuit to generate the AC signals of the corresponding conduction angle signal sequence. Also, the above-mentioned modulation module may be change-over switch, key, or other switching elements of the equivalent effect, or a variable resistor, or the combinations thereof.

Preferably, a DC power supply circuit charging switch circuit may be added between the rectifying circuit and the DC power supply circuit for the aforementioned aspect to control the conduction time at an input side of the DC power supply circuit, such that the zero-crossing signal of the load end is precluded from distortion, which distortion may result in a detection error of the conduction angle. In other words, the DC power supply circuit charging switch circuit may control the power pick-up time of the DC power supply circuit, so that the conduction angle modulation circuit will not pick-up power when the triple-pole AC switch is off, which may result in the distortion of the zero-crossing signal at the load end, and render the conduction angle cannot be detected correctly.

In addition, the bleeder circuit of the afore-mentioned aspect may be an active bleeder circuit. When the triple-pole AC switch is in a non-conducting state, the active bleeder circuit is turned on momentarily, so that the DC power supply circuit of the conduction angle modulation circuit may store current for each of the circuits in use. In other words, the active bleeder circuit may cooperate with a switch circuit of the conduction angle modulation circuit to act as a switch, so that sufficiently large current may flow through the DC power supply circuit of the conduction angle modulation circuit in an extremely short period of conduction time during which the triple-pole AC switch is off, whereby sufficient energy may be stored for each of the circuits without distorting the zero-crossing at the load end, and thus will not affect the operation of the conduction angle detection circuit.

The load end may include a LED light source and a drive circuit thereof, and a control command controls the luminance, color or color temperature of the LED light source. Alternatively, the load end may include a fan and a drive circuit thereof, and a control command controls the rotational speed or orientation of the fan. In other words, the present invention is applicable to any electrical appliances with controllable load, such as LED light sources, electric motors, and fans. The loads may all be controlled simultaneously or separately.

Additionally, the present invention provides a modulating method using the variation of an AC voltage conduction angle as a control command to modulate a load. The conduction angle of the alternate current is constant and approximate to 180 degrees during stable operation, and the conduction angle is modulated only when the state of the load is to be changed. The method according to the present invention includes the steps of: modulating the conduction angle of the alternate current by means of a conduction angle modulation circuit; then, detecting the conduction angle of the alternate current by means of a conduction angle detection circuit, and generating a conduction angle signal; and controlling the load by means of a control unit according to the conduction angle signal.

Preferably, the above-mentioned conduction angle modulation circuit may modulate AC conduction angles of multiple cycles to form a signal sequence, and transmit the signal sequence repeatedly for several times. The conduction angle detection circuit may detect the signal sequence, and generate the conduction angle signal. In addition, the control unit may decode the conduction angle signal, and in response, generate a control command, and control the load according to the control command.

The modulating apparatus and method of the present invention that make use of the control command for an AC conduction angle do not need to add an extra wiring. That is, existing lines are sufficient for the AC signal to efficiently perform functional modulation of the load without encounting the problem of low power factor.

### BRIEF DESCRIPTION OF THE DRAWINGS

FIG. 1 is a block diagram of a system according to the first embodiment of the present invention.

FIG. 2 is a circuit diagram of the first embodiment according to the present invention.

FIG. 3 is a schematic drawing showing the operation of the first embodiment.

FIG. 4 is a block diagram of a system according to the second embodiment of the present invention.

FIG. 5 is a circuit diagram of the second embodiment according to the present invention.

FIG. 6 is a block diagram of a system according to the third embodiment of the present invention.

FIG. 7 is a circuit diagram of the third embodiment according to the present invention.

### DETAILED DESCRIPTION OF THE PREFERRED EMBODIMENT

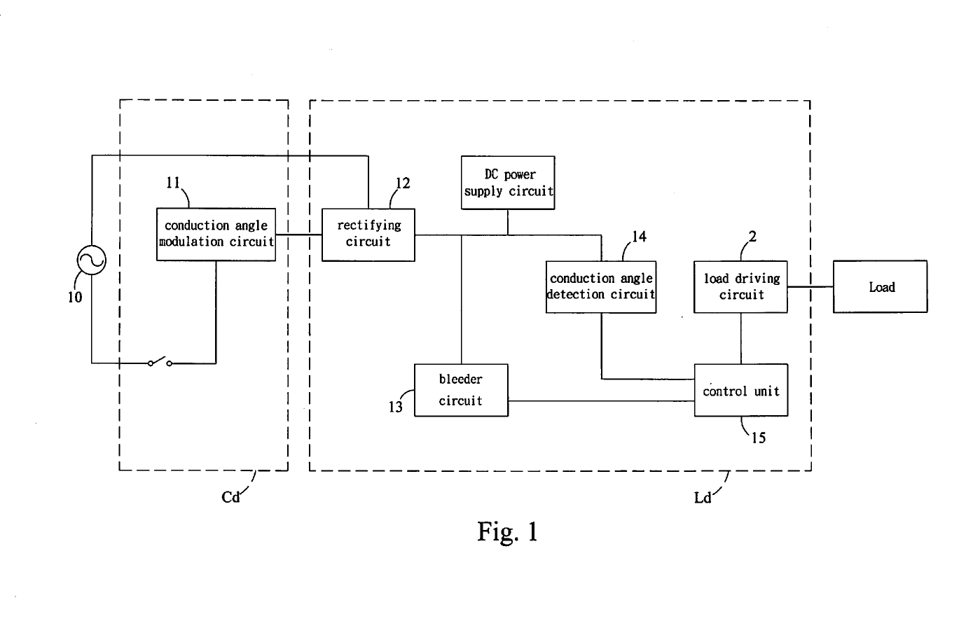

FIG. 1 shows a block diagram of a modulating system according to the present invention which may modulate the load by means of a control command obtained by varying the conduction angle of an AC voltage. As shown in the figure, the modulating apparatus according to this embodiment is arranged at a control end Cd and at a load end Ld. The control end Cd includes a conduction angle modulation circuit 11, and may be a wall hanging control device or a remote control device. The load end Ld includes a rectifying circuit 12, a bleeder circuit 13, a conduction angle detection circuit 14, a control unit 15 and a load driving circuit 2.

As shown in the figure, the conduction angle modulation circuit 11 is electrically connected to an AC power supply 10 for the supply of an alternating current, and only will modulate the conduction angle when the state of the load is to be changed. The conduction angle is normally kept at its original state. In addition, the rectifying circuit 12 at the load end Ld is electrically connected to the conduction angle modulation circuit 11 to rectify the modulated AC signal. The conduction angle detection circuit 14 is electrically connected to the rectifying circuit 12, and is used to detect the conduction angle modulated by the conduction angle modulation circuit 11, and output a conduction angle signal. The bleeder circuit 13 is electrically connected with the rectifying circuit 12, and provides the triple-pole AC switch with sufficient latching current and holding current in order to avoid the triple-pole AC switch from false triggering.

The control unit 15 is electrically connected to the conduction angle detection circuit 14 and the load driving circuit 2. If an active bleeder circuit is used, the control unit 15 may also be connected to the bleeder circuit 13. The control unit 15 is used primarily to decode the conduction angle signal to obtain a control command. The conduction angle is constant, i.e. approximate to 180 degrees, during stable operation. When the state of the load is to be changed, the conduction angle modulation circuit 11 modulates the conduction angle of the AC power supply 10, and the conduction angle signal is output to the control unit 15 after having been detected by the conduction angle detection circuit 14. The control unit 13 then decodes the conduction angle signal and generates the control command in response, and controls the operation of the load driving circuit 2. For the sake of clarity in description, in the descriptions hereinbelow, a LED light source is taken as an example of the load applicable to this embodiment.

There are two aspects of signal modulating modes provided for the conduction angle modulation circuit 11. The first aspect is a conduction angle modulation mode without a microprocessor, where the size of the conduction angle plays the major role as the control command. The second aspect is a conduction angle modulation mode using a microprocessor, where not only the size of the conduction angle is used as the control command, as the first aspect does, but also a serial conduction angle signal sequence is generated to achieve the object of accurate multiplexing remote control.

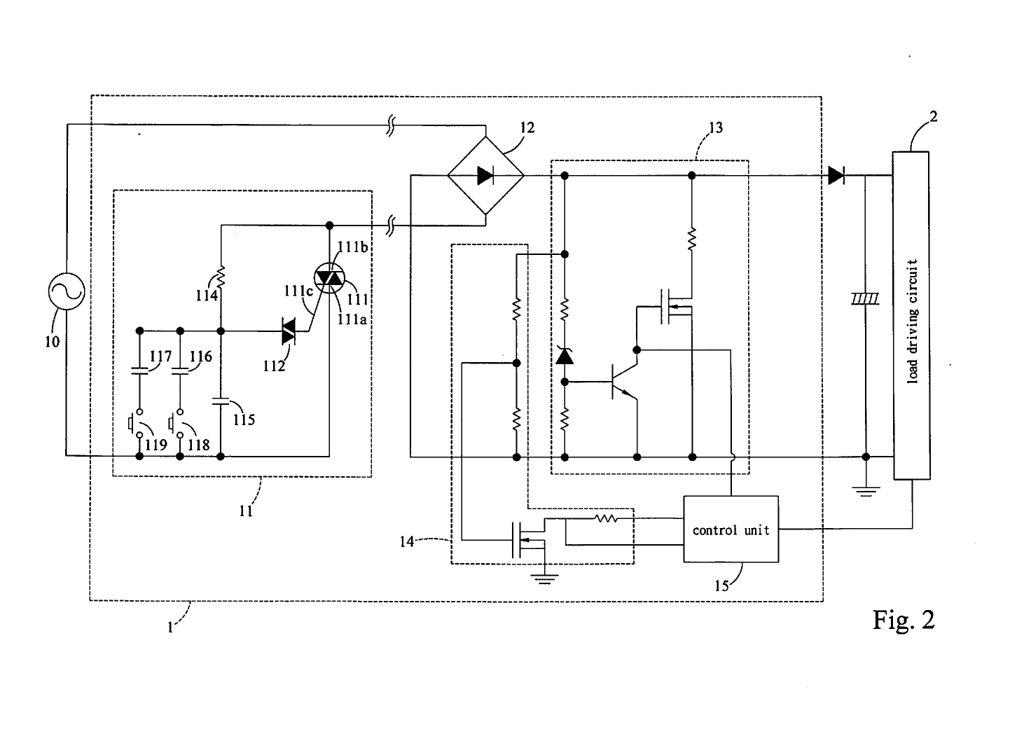

Firstly, the signal modulating mode of the first aspect is described. Referring to FIG. 2 which shows the circuit diagram of the first embodiment according to the present invention. The conduction angle modulation circuit 11 includes: a triple-pole AC switch 111, a bipolar AC switch 112, a resistor 114, a capacitor 115, a first switched capacitor 116, a second switched capacitor 117, a first switching unit 118 and a second switching unit 119. The triple-pole AC switch 111 comprises a first terminal 111a, a second terminal 111b and a gate 111c, while the second terminal 111b is electrically connected to the load driving circuit 2. The first switched capacitor 116 is connected with the first change-over switch 118 in series, and is connected to the capacitor 115 in parallel after it is connected with the first change-over switch 118 in series. The second switched capacitor 117 is connected with the second switching unit 119 in series, and is connected with the capacitor 115 in parallel after it is connected with the second switching unit 119 in series. Preferably, the first change-over switch 118 and the second change-over switch 119 are bounce switches.

The manipulation and operation procedures of this embodiment are detailed hereinbelow. The conduction angle is 170 degrees during normal operation, and changes to 155 degrees when the first change-over switch 118 is pressed. The conduction angle restores to 170 degrees when the first change-over switch 118 is released. The conduction angle changes to 140 degrees when the second change-over switch 119 is pressed; and the conduction angle returns to 170 degrees when the second change-over switch is released. Accordingly, the control unit 15 performs decoding according to the modulated conduction angle signal detected by the conduction angle detection circuit 14. In this embodiment, the luminance of the loaded LED lamp is changed as the conduction angle is 140 degrees, the color of the loaded LED lamp is changed as the conduction angle is 155 degrees, and the LED lamp remains at its original state as the conduction angle is 170 degrees.

In other words, this embodiment is characterized in that the first switched capacitor 116 and the second switched capacitor 117 have different capacitances, and switching of the first change-over switch 118 and the second change-over switch 119 corresponds to conduction of the first switched capacitor 116 and the second switched capacitor 117, respectively. As such, the conduction angle modulation circuit 11 will generate AC voltages with different conduction angles. The conduction angle detection circuit 14 detects the size of the conduction angle of the alternating voltage that has been modulated, which is provided for the microprocessor 15 to generate different corresponding controls for driving the operation of the load according to the AC voltages with different conduction angles. Those different control commands may be used to control the luminance or color temperature of the LED light source. For example, the luminance of the LED light source will undergo loop change when the first change-over switch 118 is pressed, and the color temperature of the LED light source will switch when the second change-over switch 119 is pressed.

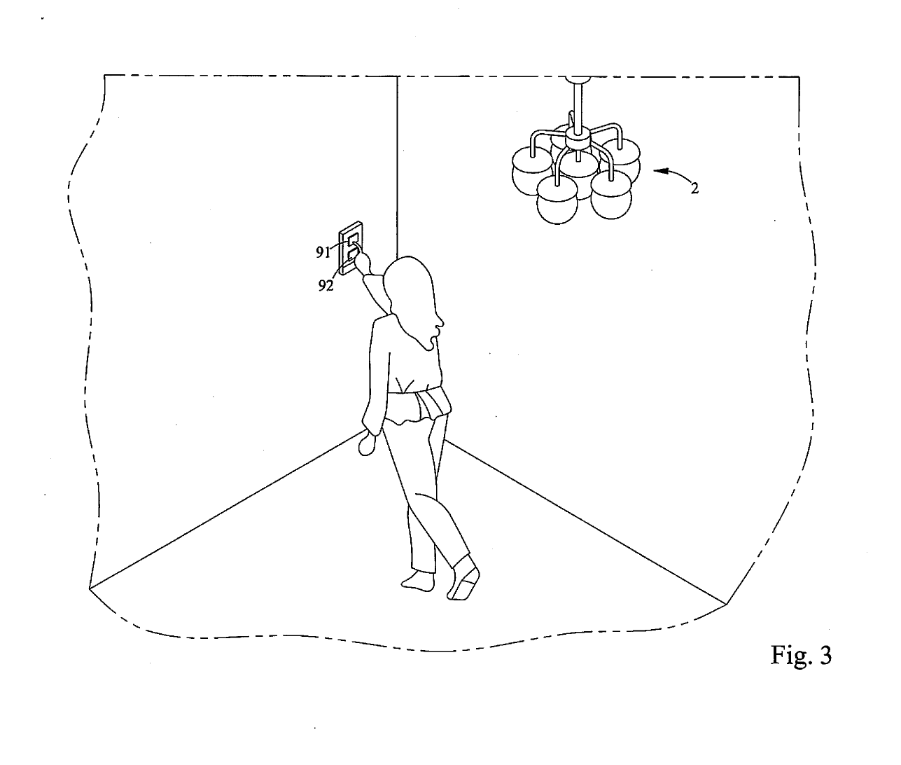

Referring now to FIGS. 2 and 3, in which FIG. 3 schematically shows the operation of a preferred example according to the present invention. As shown, two push-button switches 91, 92 correspond to the first change-over switch 118 and the second change-over switch 119, respectively. The push-button switches 91, 92 may make switches between different capacitors to generate different control commands of conduction angles. In this embodiment, the conduction angle modulation circuit 11 is designed for a wall hanging control end so that a user may press the switches 91, 92 to switch to the first change-over switch 118 and the second change-over switch 119. The present embodiment includes, but is not limited to two switched capacitors and two change-over switches. Three switched capacitors which are separately connected in parallel with three change-over switches, or four switched capacitors which are separately connected in parallel with four change-over switches may be applied. By switching the switched capacitors of different capacitances, AC signals with different conduction angles may be generated for multiplexing control.

The switching mode of the first aspect according to the present invention includes but is not limited to the mode performed by switching the aforementioned switched capacitor, and that performed by switching a switched resistor may be applied. Here, the switched capacitors are replaced with switched resistors, and the switched resistors and change-over switches are connected in parallel with the resistors. Likewise, the control mode associated with such conduction angle modulation mode will vary with the quantity of the switched resistors and change-over switches arranged.

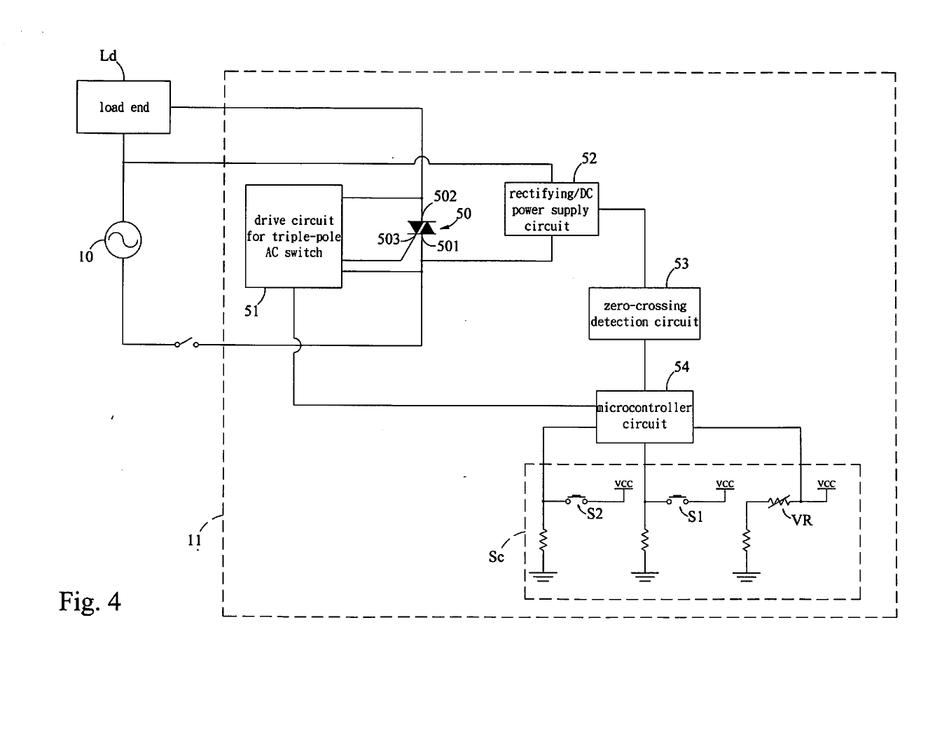

Furthermore, the signal modulating mode of the second aspect according to the present invention embodies, for example, two embodiments, namely the second and third embodiments. Referring to FIG. 4 which shows a system block diagram of the second embodiment according to the invention. The conduction angle modulation circuit 11 includes a triple-pole AC switch 50, a drive circuit for the triple-pole AC switch 51, a rectifying/DC power supply circuit 52, a zero-crossing detection circuit 53, a microcontroller circuit 54 and a modulation module Sc. The triple-pole AC switch 50 comprises a first terminal 501, a second terminal 502 and a gate 503. The second terminal 502 is electrically connected to the load end Ld.

The drive circuit for the triple-pole AC switch 51 is electrically connected to a gate 503 of the triple-pole AC switch 50. The rectifying/DC power supply circuit 52 is electrically connected to two power supply terminals of the AC power supply 10, and provides each of the circuits with DC power supply. The zero-crossing detection circuit 53 is electrically connected to the rectifying/DC power supply circuit 52, and the zero-crossing detection circuit 53 detects the zero-crossing signal of the alternating current 10.

Additionally, the microcontroller circuit 54 is electrically connected to the zero-crossing detection circuit 53 and the drive circuit for the triple-pole AC switch 51. The microcontroller circuit 54 drives the triple-pole AC switch 50 through by controlling the drive circuit for the triple-pole AC switch 51, so as to modulate the conduction angle of the alternating current according to the zero-crossing signal of the alternating current provided by the zero-crossing detection circuit 53.

The modulation module Sc is electrically connected to the microcontroller circuit 54, and is modulated to activate the microcontroller circuit 54 and generate AC signals of different combinations of conduction angles in a controlled manner. In this embodiment, the modulation module Sc includes two change-over switches S1, S2 and a variable resistor VR. By turning on or off the change-over switches S1, S2 and adjusting the variable resistor VR, different voltages are input to the microcontroller circuit 54, so that the microcontroller circuit 54 may control the conduction angle modulation circuit 11 to generate AC signals of different combinations of conduction angles. The modulation module Sc according to the present invention includes but is not limited to change-over switch and variable resistor. Other modulation means that may cooperate with the microcontroller circuit 54 is also applicable to the present invention.

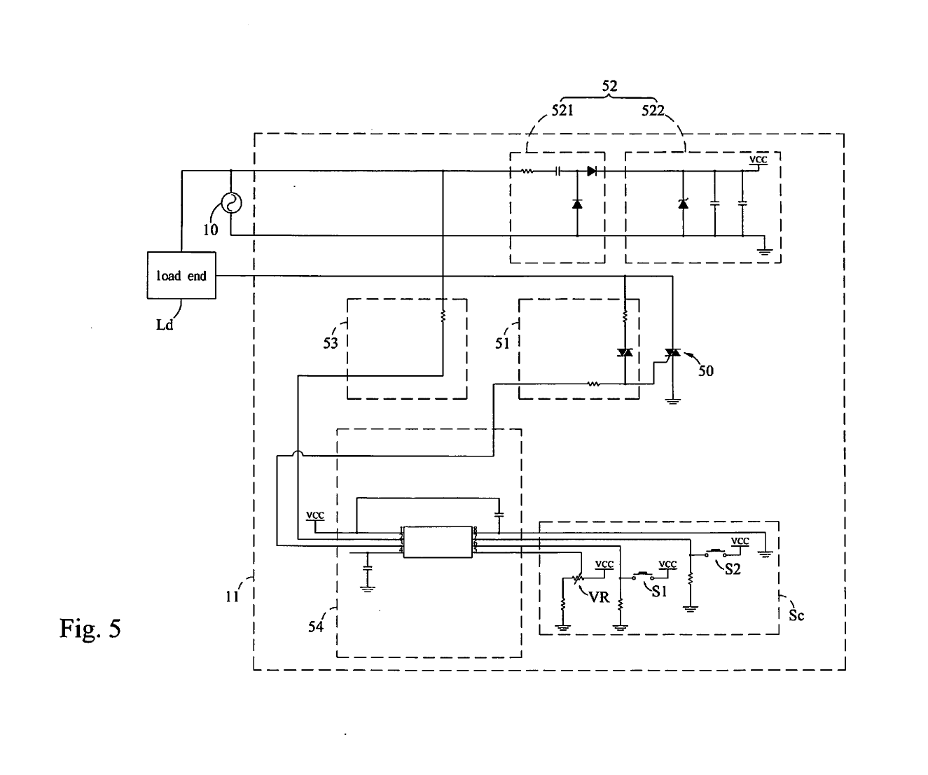

Referring to FIG. 5 which shows a circuit diagram of the second embodiment according to the present invention. However, FIG. 5 illustrates only one of the possible implementation layouts of the second embodiment. As the circuit layouts for the drive circuit of the triple-pole AC switch drive circuit 51, the rectifying/DC power supply circuit 52, the zero-crossing detection circuit 53 and the microcontroller circuit 54 are well known in the art, the descriptions thereof are omitted. However, the second embodiment of the present invention includes but is not limited to the circuit layout as illustrated in this figure, as circuits of the equivalent effect and function are also applicable. In particular, the triple-pole AC switch 50 in this embodiment may be replaced with SCR (Silicon Controlled Rectifier) or other elements of the equivalence.

The manipulation and operation procedures of this embodiment are detailed hereinbelow. The conduction angle is 170 degrees during normal operation. When either one of the change-over switches S1, S2 is pressed and/or the variable resistance VR adjusted, three sets of conduction angle signal sequences of 4 cycles will be generated. The conduction angles in the signal sequence may be 170 degrees, 155 degrees and 140 degrees. The first conduction angle is the signal start code, which is a conduction angle of 140 degrees. The second conduction angle and the third conduction angle are the control commands corresponding to the change-over switches S1, S2, and may be different combinations of the three conduction angles. The conduction angle of the fourth cycle is a checksum. Next, the control circuit 15 decodes the modulated conduction angle signal detected by the conduction angle detection circuit 14, and generates a control command in response, and controls the operation of the load driving circuit 2 according to the control command, just like the operation of a normal remote controller.

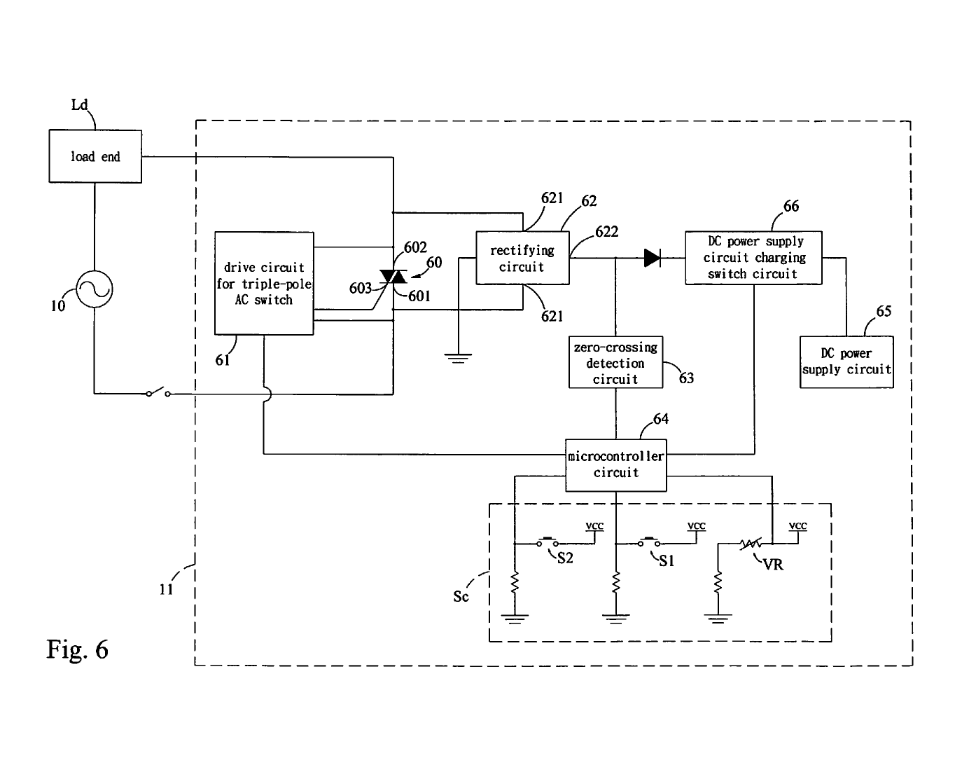

Referring now to FIG. 6 which shows a circuit diagram of the third embodiment according to the present invention. The difference between the third embodiment and the second embodiment resides in the DC power supply generation circuits. The second embodiment needs to make use of the power supplies at two ends of the AC power supply 10. That is to say, two power lines of the alternating current have to be used for the arrangement. To the contrary, in the third embodiment, only one end of the AC power supply 10 is needed. That is to say, only one power line of the alternating current has to be used. As such, the installation and/or maintenance become simpler and more convenient.

As shown in the figure, the conduction angle modulation circuit 11 according to the third embodiment of the present invention includes a triple-pole AC switch 60, a drive circuit for the triple-pole AC switch 61, a rectifying circuit 62, a zero-crossing detection circuit 63, a microcontroller circuit 64, a DC power supply circuit 65, a DC power supply circuit charging switch circuit 66, and a modulation module Sc. The triple-pole AC switch 60 comprises a first terminal 601, a second terminal 602 and a gate 603, and the second terminal 602 is electrically connected to the load end Ld.

In addition, the triple-pole AC switch drive circuit 61 is electrically connected to the gate 603 of the triple-pole AC switch 60. The rectifying circuit 62 comprises an AC terminal 621 and a DC terminal 622, and the two terminal points of the AC terminal 621 are electrically connected to the first terminal 601 and the second terminal 602 of the triple-pole AC switch 60, respectively. The zero-crossing detection circuit 63 is electrically connected to the rectifying circuit 61. The zero-crossing detection circuit 62 detects the zero-crossing signal of the alternating current.

The microcontroller circuit 64 is electrically connected to the zero-crossing detection circuit 63 and the drive circuit for the triple-pole AC switch 61. The microcontroller circuit 64 drives the triple-pole AC switch 60 by controlling the drive circuit for the triple-pole AC switch 61, so as to modulate the conduction angle of the alternating current according to the zero-crossing signal of the alternating current provided by the zero-crossing detection circuit 63.

The DC power supply circuit 65 provides each of the circuits with DC power supply, and the DC power supply circuit charging switch circuit 66 is arranged between the rectifying circuit 62 and the DC power supply circuit 65. The DC power supply circuit charging switch circuit 66 is used to control conduction time on an input side of the DC power supply circuit 65 in order to prevent the zero-crossing signal of the load end Ld from distortion, and in turn avoid error in detecting the conduction angles.

The modulation module Sc is electrically connected to the microcontroller circuit 64, and is modulated to activate the microcontroller circuit 64 to generate AC signals of different combinations of conduction angles in a controlled manner. In this embodiment, the modulation module Sc includes two change-over switches S1, S2 and a variable resistor VR. By turning on or off the change-over switches S1, S2 and adjusting the variable resistor VR, different voltages are input to the microcontroller circuit 54, such that the microcontroller circuit 54 controls the conduction angle modulation circuit 11 to generate AC signals of different combinations of conduction angles. It is to be noted that the modulation module Sc includes but is not limited to change-over switch or variable resistor, and other modulation means that may cooperate with the microcontroller circuit 54 is also applicable.

In this embodiment, the bleeder circuit 13 of the load end Ld is an active bleeder circuit. When the triple-pole AC switch 60 is in a non-conducting state, the active bleeder circuit will be turned on briefly, so that the DC power supply circuit 65 of the conduction angle modulation circuit 11 stores current for each of the circuits in use. In other words, the active bleeder circuit of this embodiment may cooperate with a switch circuit of the conduction angle modulation circuit 11 to perform switching continuously, so that a sufficiently large amount of current may flow through the DC power supply circuit 65 of the conduction angle modulation circuit 11 during the extremely short conduction time when the triple-pole AC switch 60 is off. Accordingly, a sufficient amount of power may be stored for each of the circuits in use, thereby preventing the zero-crossing signals of the load end Ld from distortion, which would affect the operation of the conduction angle detection circuit 14.

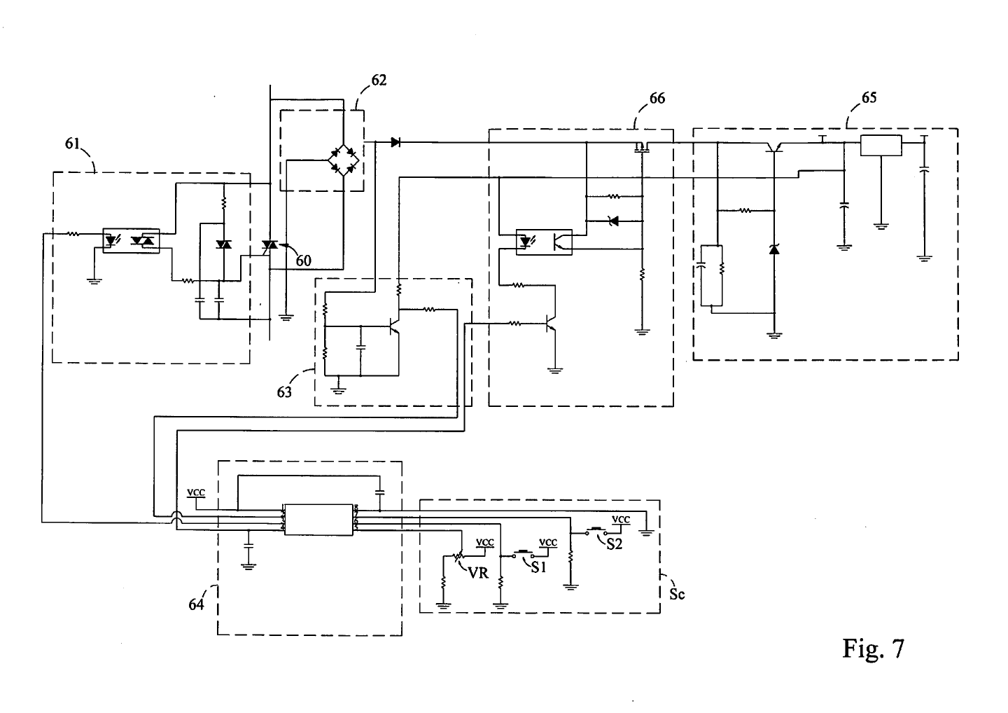

Referring FIG. 7 which shows a circuit diagram of the third embodiment according to the present invention. FIG. 7 illustrates only one of the possible implementations of the third embodiment, wherein the detailed descriptions of the circuit layouts of the drive circuit for triple-pole AC switch 61, rectifying circuit 62, zero-crossing detection circuit 63, microcontroller circuit 64, DC power supply circuit 65 and the DC power supply circuit charging switch circuit 66 are all conventional and thus are omitted. Further, the third embodiment according to the present invention includes but is not limited to the circuit layout as illustrated in FIG. 7. Other circuits of the equivalent functions and effects are also applicable. Furthermore, the triple-pole AC switch 60 applied in this embodiment may be replaced with SCR (Silicon Controlled Rectifier) or other elements of the equivalent. As to the detailed manipulation and operation of this embodiment, reference may be made to those mentioned in the second embodiment.

With the modulating apparatus 1 provided by the present invention which makes use of the alternating current conduction angle to generate the control command, complex and complicated control circuits are not needed for the load driving circuit 2, and no extra wiring is needed. Existing wiring is sufficient for the use of the AC signals to modulate the load. Therefore, the present invention is low in manufacturing cost, easy to maintain, and convenient to use.

While the preferred embodiments have been described as above, it is to be noted that the description and accompanying drawings disclosed herein are not intend to restrict the scope of implementation of the present invention. Variations and modifications equivalent to the above embodiments and able to be realized are considered to be within the scope of the present invention.

What is claimed is:

1. An apparatus for modulating a load by means of a control command obtained by varying a conduction angle of an AC voltage, the apparatus comprising a conduction angle modulation circuit electrically connected to an AC power supply for modulating the conduction angle of the AC power supply; wherein the conduction angle is constant during stable operation, and
the conduction angle modulation circuit modulates the conduction angle of multiple cycles of the AC power supply to form a signal sequence so as to control the operation of the load when the state of the load is to be changed.

2. The apparatus of claim 1, further comprising a load end control circuit arranged at a load end, the conduction angle modulation circuit being arranged at a control end, the load end control circuit comprising a conduction angle detection circuit electrically connected to the conduction angle modulation circuit for detecting the conduction angle modulated by the conduction angle modulation circuit so as to output a conduction angle signal, and a control unit electrically connected to the conduction angle detection circuit for decoding the conduction angle signal as a control command.

3. The apparatus of claim 2, wherein the conduction angle modulation circuit includes:
a triple-pole AC switch comprising a first terminal, a second terminal and a gate, the second terminal being electrically connected to the load end;
a drive circuit for the triple-pole AC switch electrically connected to the gate of the triple-pole AC switch;
a rectifying/DC power supply circuit electrically connected to both power supply terminals of the AC power supply for supplying DC power to each of the circuits;
a zero-crossing detection circuit electrically connected to the rectifying/DC power supply circuit for detecting a zero-crossing signal of the alternating current;
a microcontroller circuit electrically connected to the zero-crossing detection circuit and the drive circuit for the triple-pole AC switch, the microcontroller circuit being adapted to drive the triple-pole AC switch by controlling the drive circuit for the triple-pole AC switch, so as to modulate the conduction angle of the alternating current dependent on the zero-crossing signal of the alternating current provided by the zero-crossing detection circuit; and
a modulation module electrically connected to the microcontroller circuit, the modulation module being configurable to activate the microcontroller circuit to generate AC signals of different combinations of conduction angles in a controlled manner.

4. The apparatus of claim 2, wherein the conduction angle modulation circuit comprises:
a triple-pole AC switch having a first terminal, a second terminal and a gate, the second terminal being electrically connected to the load end;
a drive circuit for the triple-pole AC switch electrically connected to the gate of the triple-pole AC switch;
a rectifying circuit having an AC terminal electrically connected to the first terminal of the triple-pole AC switch, and a DC terminal electrically connected to the second terminal of the triple-pole AC switch;
a zero-crossing detection circuit electrically connected to the rectifying circuit for detecting a zero-crossing signal of the alternating current;
a microcontroller circuit electrically connected to the zero-crossing detection circuit and the drive circuit for the triple-pole AC switch, the microcontroller circuit being adapted to drive the triple-pole AC switch by controlling the drive circuit for the triple-pole AC switch, so as to modulate the conduction angle of the alternating current dependent on the zero-crossing signal of the alternating current provided by the zero-crossing detection circuit;
a DC power supply circuit for supplying DC power to each of the circuits; and
a modulation module electrically connected to the microcontroller circuit, the modulation module being configurable to activate the microcontroller circuit to generate AC signals of different combinations of conduction angles in a controlled manner.

5. The apparatus of claim 3, wherein the load end control circuit further comprises:
a rectifying circuit electrically connected between the conduction angle modulation circuit and the conduction angle detection circuit, and
a bleeder circuit electrically connected between the rectifying circuit and the control unit;
wherein the rectifying circuit is adapted to rectify the AC power supply modulated by the conduction angle modulation circuit, and wherein the bleeder circuit is adapted to provide a conduction current for maintaining conduction of the triple-pole AC switch in the conduction angle modulation circuit.

6. The apparatus of claim 3, wherein the modulation module includes at least one change-over switch which is switchable to activate the microcontroller circuit to control the conduction angle modulation circuit to generate AC signals of different combinations of conduction angles.

7. The apparatus of claim 3, wherein the modulation module includes a variable resistor, different voltages being input to the microcontroller circuit by adjusting the variable resistor, whereby the microcontroller circuit is activated to control the conduction angle modulation circuit to generate AC signals of different combinations of conduction angles.

8. The apparatus of claim 4, wherein a charging switch circuit for the DC power supply circuit is arranged between the rectifying circuit and the DC power supply circuit to control the conduction time at an input side of the DC power supply circuit, so as to prevent the zero-crossing signal of the load end from distortion, and in turn avoid error in the detection of conduction angle.

9. The apparatus of claim 5, wherein the bleeder circuit comprises an active bleeder circuit which is adapted to turn on momentarily when the triple-pole AC switch is in a non-conducting state, so that the DC power supply circuit of the conduction angle modulation circuit stores current for each of the circuits.

10. A method for modulating a load by means of a control command obtained by varying a conduction angle of an AC voltage, the conduction angle of the alternating current being constant during stable operation, and the conduction angle being modulated only when the state of the load is to be changed, the method includes the steps of:
(A) modulating the conduction angle of multiple cycles of the alternating current to form a signal sequence by means of a conduction angle modulation circuit;
(B) detecting the signal sequence by means of a conduction angle detection circuit, and generating a conduction angle signal; and
(C) controlling the load by means of a control unit based on the conduction angle signal.

11. The method of claim 10, wherein the step of modulating the conduction angle of multiple cycles of the alternating current comprises transmitting the signal sequence repeatedly for several times.

12. The method of claim 10, wherein the step of controlling the load further comprises the steps of:
(C1) decoding the conduction angle signal by means of the control unit, and generating a control command in response; and
(C2) controlling the load by means of the control unit according to the control command.

13. The apparatus of claim 4, wherein the load end control circuit further comprises:
a rectifying circuit electrically connected between the conduction angle modulation circuit and the conduction angle detection circuit; and
a bleeder circuit electrically connected between the rectifying circuit and the control unit,
wherein the rectifying circuit is adapted to rectify the AC power supply modulated by the conduction angle modulation circuit, and wherein the bleeder circuit is adapted to provide a conduction current for maintaining conduction of the triple-pole AC switch in the conduction angle modulation circuit.

14. The apparatus of claim 4, wherein the modulation module includes at least one change-over switch which is switchable to activate the microcontroller circuit to control the conduction angle modulation circuit to generate AC signals of different combinations of conduction angles.

15. The apparatus of claim 4, wherein the modulation module includes a variable resistor, different voltages being input to the microcontroller circuit by adjusting the variable resistor, whereby the microcontroller circuit is activated to control the conduction angle modulation circuit to generate AC signals of different combinations of conduction angles.
